(19) United States
(12) Patent Application Publication
(10) Pub. No.: US 2025/0055955 A1
(43) Pub. Date: Feb. 13, 2025

(54) COMPUTER

(71) Applicant: Wacom Co., Ltd., Saitama (JP)

(72) Inventors: Tatsunori KATO, Saitama (JP); Yoshihiro KOTANI, Saitama (JP); Hiroyuki SAKUMA, Saitama (JP); Joo Hoon LEE, Saitama (JP); Hiroshi MIZUHASHI, Saitama (JP)

(21) Appl. No.: 18/930,765

(22) Filed: Oct. 29, 2024

Related U.S. Application Data
(63) Continuation of application No. PCT/JP2023/017244, filed on May 8, 2023.

(30) Foreign Application Priority Data
May 9, 2022 (JP) 2022-076942

(51) Int. Cl. H04N 5/265; G06F 3/0354; G06T 11/20

(52) U.S. Cl. CPC H04N 5/265; G06F 3/03545; G06T 11/203

(57) ABSTRACT

To prevent a delay in display of a stroke image due to a delay in processing in a computer without the provision of an overlay engine in a timing controller. A computer includes a host processor that generates a stroke image representing a stroke indicated by a series of pieces of coordinate data each representing the position of a pen on a touch surface, and generates a video signal representing the generated stroke image, a timing controller that controls the potential of each of a plurality of gate lines arranged in a display panel, based on a video signal, and an MCU that generates, in parallel with the host processor, a provisional stroke image representing the same stroke as the stroke represented by the stroke image. The above-described provisional stroke image is superimposed onto the video signal that has not yet been supplied to the timing controller.

### BACKGROUND

### Technical Field

The present disclosure relates to a computer, and relates particularly to a computer that can prevent a delay in display of a stroke image.

### Description of the Related Art

In a computer such as a tablet terminal that supports pen input, data such as coordinate data indicating the position of a pen and a pen pressure value transmitted by the pen (which data will hereinafter be referred to collectively as “pen data”) is supplied from a sensor controller connected to a touch sensor to a host processor. The host processor performs processing of generating a stroke image representing a stroke on the basis of the supplied pen data, and displaying the generated stroke image on a display.

Patent Document 1 discloses an example of a computer that supports pen input. In the computer described in the document, in order to avoid a delay in display of the stroke image due to a delay in processing in the computer, an overlay engine is provided in a timing controller as a constituent part of the display, and the coordinate data is directly transmitted from the sensor controller to the overlay engine. The overlay engine performs processing of generating a provisional stroke image on the basis of the coordinate data received from the sensor controller, and updating a display frame received from the host processor on the basis of the generated provisional stroke image.

Patent Document 2 discloses an example of a liquid crystal display device including a graphics processing circuit including a scaler in a stage preceding the timing controller.

### PRIOR ART DOCUMENT

### Patent Documents

Patent Document 1: U.S. Pat. No. 9,721,365

Patent Document 2: Japanese Patent Laid-Open No. 2008-233869

### BRIEF SUMMARY

### Technical Problems

The technology described in Patent Document 1 can prevent a delay in display of the stroke image, but presents a problem in that the overlay engine needs to be provided in the timing controller as a constituent part of the display. There is accordingly a need for a technology that can prevent a delay in display of the stroke image without the provision of the overlay engine in the timing controller.

Hence, embodiments of the present disclosure provide a computer that can prevent a delay in display of a stroke image without the provision of an overlay engine in a timing controller.

### Technical Solution

A computer according to the present disclosure is a computer including a host processor that, in operation, generates a stroke image representing a stroke indicated by a series of pieces of coordinate data each representing a position of a pen in a touch surface, and generates a video signal representing the generated stroke image, a timing controller that, in operation, controls a potential of each of a plurality of gate lines arranged in a display, based on the video signal, and a provisional stroke image generating processor that, in operation, generates, in parallel with the host processor, a provisional stroke image representing a same stroke as the stroke represented by the stroke image, wherein the provisional stroke image is superimposed onto the video signal before the video signal is supplied to the timing controller.

### Advantageous Effect

According to the present disclosure, the provisional stroke image representing the same stroke as the stroke image generated by the host processor is generated in parallel with the host processor, and is superimposed onto the video signal that has not yet been supplied to the timing controller. It is therefore possible to prevent a delay in display of the stroke image without the provision of an overlay engine in the timing controller.

### BRIEF DESCRIPTION OF THE SEVERAL VIEWS OF THE DRAWINGS

FIG. 1 is a diagram illustrating a configuration of a position detection system 2 including a computer 1 according to a first embodiment of the present disclosure.

FIG. 2 is a diagram illustrating an internal configuration of a video board 13 and a display panel 14 according to the first embodiment of the present disclosure.

FIG. 3 is a diagram illustrating a configuration of a position detection system 2 including a computer 1 according to a second embodiment of the present disclosure.

FIG. 4 is a diagram illustrating a configuration of a position detection system 2 including a computer 1 according to a third embodiment of the present disclosure.

FIG. 5 is a diagram illustrating an internal configuration of a video board 13 and a display panel 14 according to the third embodiment of the present disclosure.

FIG. 6 is a diagram illustrating a configuration of a position detection system 2 including a computer 1 according to a fourth embodiment of the present disclosure.

FIG. 7 is a diagram illustrating an internal configuration of a video board 13 and a display panel 14 according to the fourth embodiment of the present disclosure.

FIG. 8 is a diagram illustrating a configuration of a position detection system 2 including a computer 1 according to a fifth embodiment of the present disclosure.

FIG. 9 is a diagram illustrating an internal configuration of a video board 13 and a display panel 14 according to the fifth embodiment of the present disclosure.

### DETAILED DESCRIPTION

Embodiments of the present disclosure will hereinafter be described in detail with reference to the accompanying drawings.

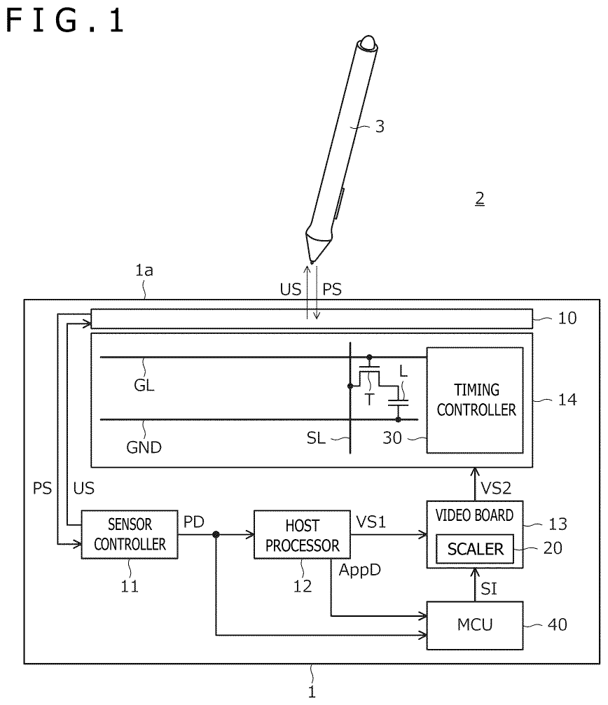

FIG. 1 is a diagram illustrating a configuration of a position detection system 2 including a computer 1 according to a first embodiment of the present disclosure. As illustrated in FIG. 1, the position detection system 2 includes an electronic pen 3 in addition to the computer 1.

The computer 1 is a computer such as, for example, a tablet terminal or a smart phone that has a panel surface 1a serving both as a touch surface and a display surface. However, the computer 1 may be a computer such that a touch panel or a digitizer supporting pen input and a display for making display are provided separately from each other.

The computer 1 and the electronic pen 3 are configured to be able to communicate with each other bidirectionally by an electromagnetic induction system (EMR system). In the following, a signal transmitted from the computer 1 to the electronic pen 3 by this communication will be referred to as an “uplink signal US,” and a signal transmitted from the electronic pen 3 to the computer 1 by this communication will be referred to as a “pen signal PS.” Incidentally, the computer 1 and the electronic pen 3 may communicate with each other by another system such as an active capacitance system, for example.

The computer 1 includes a sensor 10, a sensor controller 11, a host processor 12, a video board 13, a display panel 14, and an MCU (Micro Controller Unit) 40.

The sensor 10 includes a plurality of loop coils arranged on the inside of the panel surface 1a. One end of each of the loop coils is connected to the sensor controller 11, and another end thereof is grounded. Each of the loop coils plays a role of supplying operating power and a command to the electronic pen 3 and receiving the pen signal PS transmitted by the electronic pen 3 by coupling to a coil in an LC resonance circuit provided to the inside of the electronic pen 3 through electromagnetic induction.

The sensor controller 11 is an integrated circuit that transmits the uplink signal US to the electronic pen 3 via the sensor 10, and receives the pen signal PS transmitted by the electronic pen 3 as a reflection signal in response to the uplink signal US via the sensor 10. The uplink signal US is a signal for supplying operating power and a command to the electronic pen 3. The uplink signal US is periodically transmitted from the sensor controller 11. The electronic pen 3 is configured to store power in a capacitor in the LC resonance circuit while the electronic pen 3 is receiving the uplink signal US, and transmit the pen signal PS by using the stored power when the electronic pen 3 ends the reception of the uplink signal US.

Each time the sensor controller 11 transmits the uplink signal US, the sensor controller 11 performs processing of deriving coordinate data indicating the position of the electronic pen 3 in the panel surface 1a on the basis of the received pen signal PS. Specifically, the sensor controller 11 is configured to derive the coordinate data indicating the position of the electronic pen 3 by deriving a distribution of reception strength of the pen signal PS in the panel surface 1a on the basis of the reception strength of the pen signal PS in each of the loop coils, and deriving the coordinate data of the position corresponding to a peak of the distribution.

In addition, the sensor controller 11 also performs processing of obtaining a value indicating a pressure applied to a pen tip of the electronic pen 3 (which value will hereinafter be referred to as a “pen pressure value”), by detecting a change in phase of the received pen signal PS. Specifically, the capacitor constituting the LC resonance circuit of the electronic pen 3 includes a variable capacitance capacitor that changes in capacitance according to the pressure applied to the pen tip of the electronic pen 3. When the capacitance of the variable capacitance capacitor changes, the resonance frequency of the LC resonance circuit changes, and therefore, the frequency of the pen signal PS also changes. The sensor controller 11 detects the change in the frequency by detecting the change in phase of the pen signal PS, and obtains the pen pressure value on the basis of a result of the detection.

The sensor controller 11 is configured to sequentially supply the derived coordinate data and the obtained pen pressure value to the host processor 12 and the MCU 40. In the following, these pieces of data supplied from the sensor controller 11 to the host processor 12 and the MCU 40 may be referred to collectively as “pen data PD.”

The host processor 12 is a central processing unit of the computer 1. The host processor 12 is configured to execute various kinds of applications including an operating system of the computer 1 and a drawing application supporting pen input by reading a program from a storage device not illustrated and executing the program. Processing performed by the host processor 12 includes processing of generating a video signal VSI representing a desktop image of the computer 1 and supplying the video signal VSI to the video board 13.

The drawing application is an application having a function of generating a stroke image representing a stroke indicated by the pen data PD supplied from the sensor controller 11 and disposing the generated stroke image in the desktop image. The stroke is the trajectory of the pen tip represented by a series of pieces of coordinate data obtained while the pen pressure value is a value higher than 0 (that is, a value indicating that the pen tip of the electronic pen 3 is in contact with the panel surface 1a). In addition, the stroke image is a curve image formed by providing a line width corresponding to the pen pressure value to an approximate curve formed by smoothly connecting the series of pieces of coordinate data constituting the stroke. Examples of the approximate curve include a Bezier curve, a Catmull-Rom curve, and the like. The drawing application is configured to, in a case where drawing data AppD such as a brush size and a line color is set in the drawing application, generate the stroke image also according to the set drawing data AppD.

The video board 13 is a device that converts the video signal VSI supplied from the host processor 12 into a video signal VS2 as a signal corresponding to the display panel 14. Specifically, the video board 13 includes a scaler 20 as an integrated circuit for adjusting each of the resolution, the frame rate, and the color of the video signal VSI to values that can be supplied to the display panel 14, and the video board 13 is configured to supply the display panel 14 with the video signal VS2 as the video signal VS1 obtained after the adjustment by the scaler 20.

The display panel 14 is a device that displays video corresponding to the video signal VS2 on the panel surface 1a. A specific kind of the display panel 14 is not particularly limited to any kind. The display panel 14 may be a liquid crystal display or an organic EL display, for example. Supposing in the following that the display panel 14 is a TFT (Thin Film Transistor) type liquid crystal display, the display panel 14 includes a plurality of pixels each including a thin film transistor T and a liquid crystal element L, a plurality of gate lines GL, a plurality of signal lines SL, and common grounding wiring GND, as illustrated in FIG. 1. Incidentally, of these, only one pixel, one gate line GL, one signal line SL, and the common grounding wiring GND are illustrated in FIG. 1. The plurality of pixels are arranged in a form of a matrix. Each gate line GL is connected in common to each of gates of a plurality of thin film transistors T arranged in a row direction. Each signal line SL is connected in common to each of sources of a plurality of thin film transistors T arranged in a column direction.

The display panel 14 performs processing of driving each pixel in row units. Specifically, the display panel 14 determines potentials to be applied to the liquid crystal elements L of respective pixels in a row of interest on the basis of the video signal VS2, and applies the determined potentials to the respective signal lines SL. Then, the potential of the gate line GL of the row of interest is set high. Then, the potentials corresponding to the video signal VS2 are applied to the respective liquid crystal elements L of the row of interest, so that video corresponding to the video signal VS2 is displayed in the row of interest.

The display panel 14 includes a timing controller 30. The timing controller 30 is a circuit that controls the respective potentials of the plurality of gate lines GL on the basis of the video signal VS2. The timing controller 30 plays a role of controlling timings of supplying the potentials.

The MCU 40 is a processing circuit (provisional stroke image generating processor) that generates, in parallel with the host processor 12, a provisional stroke image SI representing the same stroke as the stroke image generated by the host processor 12, and superimposes the provisional stroke image SI onto the video signal VS2 that has not yet been supplied to the timing controller 30. The MCU 40 is configured to generate the provisional stroke image SI on the basis of a series of pieces of pen data PD supplied from the sensor controller 11.

Here, the provisional stroke image SI may be an image having a completely identical external appearance to that of the stroke image generated by the host processor 12, or may not be the image having the completely identical external appearance. In the former case, the MCU 40 receives the above-described drawing data AppD from the host processor 12, and generates the provisional stroke image SI on the basis of the received drawing data AppD. In the latter case, the MCU 40 may receive the whole or a part of the drawing data AppD set in the drawing application from the host processor 12, or may not receive the whole or a part of the drawing data AppD. When the MCU 40 receives the whole or a part of the drawing data AppD from the host processor 12, the MCU 40 generates the provisional stroke image SI on the basis of the received drawing data AppD. When the MCU 40 does not receive the drawing data AppD from the host processor 12, the MCU 40 generates the provisional stroke image SI on the basis of predetermined settings.

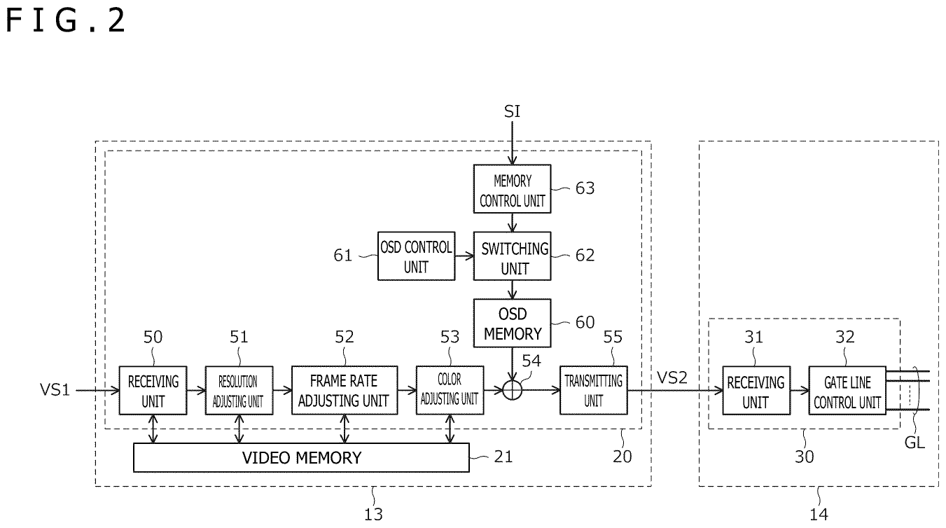

The scaler 20 in the present embodiment plays a role of actually superimposing the provisional stroke image SI supplied from the MCU 40 onto the video signal VS2. In the following, this will be described in detail with reference to FIG. 2.

FIG. 2 is a diagram illustrating an internal configuration of the video board 13 and the display panel 14 according to the present embodiment. As illustrated in FIG. 2, the video board 13 includes a video memory 21 in addition to the scaler 20. The scaler 20 includes a receiving unit 50, a resolution adjusting unit 51, a frame rate adjusting unit 52, a color adjusting unit 53, a mixer 54, a transmitting unit 55, an OSD (On-Screen Display) memory 60, an OSD control unit 61, a switching unit 62, and a memory control unit 63. In addition, the timing controller 30 includes a receiving unit 31 and a gate line control unit 32.

The receiving unit 50 is a circuit that receives the video signal VSI output by the host processor 12. The receiving unit 50 writes the received video signal VSI to the video memory 21. The video memory 21 is a storage unit configured to be able to store at least one screen of the video signal VS1.

The resolution adjusting unit 51 is a circuit that adjusts the resolution of the video signal VSI received by the receiving unit 50 according to the resolution of the display panel 14. To cite an example, in a case where the resolution of the video signal VSI is FHD (1920×1080) and the resolution of the display panel 14 is 4K (3840×2160), the resolution adjusting unit 51 performs processing of quadrupling the resolution of the video signal VS1. The resolution adjusting unit 51 is configured to read the video signal VS1 to be adjusted from the video memory 21, and overwrite the video memory 21 with the video signal VS1 obtained after the adjustment.

The frame rate adjusting unit 52 is a circuit that adjusts the frame rate of the video signal VSI obtained after the adjustment by the resolution adjusting unit 51, according to the frame rate of the display panel 14. To cite an example, in a case where the frame rate of the video signal VSI is 60 FPS and the frame rate of the display panel 14 is 30 FPS, the frame rate adjusting unit 52 performs processing of decreasing the frame rate of the video signal VSI to ½. The frame rate adjusting unit 52 is configured to read the video signal VSI to be adjusted from the video memory 21 and overwrite the video memory 21 with the video signal VSI obtained after the adjustment.

The color adjusting unit 53 is a circuit that adjusts the color of the video signal VS1 obtained after the adjustment by the frame rate adjusting unit 52 according to a color gamut of the display panel 14. To cite an example, in a case where the color gamut of the video signal VSI is sRGB and the color gamut of the display panel 14 is NTSC, the color adjusting unit 53 performs processing of reconstructing the color of the video signal VSI by NTSC. The color adjusting unit 53 also has a function of detecting a kind of video (a natural picture, baseball, an animated cartoon, or the like) and making a color correction according to the detected kind. The color adjusting unit 53 is configured to read the video signal VSI to be adjusted from the video memory 21 and supply the video signal VS1 obtained after the adjustment, to the mixer 54.

The OSD memory 60 is a storage unit that stores an image to be superimposed onto the video represented by the video signal VS1 (which image will hereinafter be referred to as an “OSD image”). In addition, the OSD control unit 61 is a circuit that generates the OSD image according to a user operation and that writes the OSD image to the OSD memory 60. In a typical example, the OSD image is a screen displayed when a user depresses a button provided to an edge portion of the display panel 14 to adjust the color and position of the screen. The OSD memory 60 is configured to be able to store an image of at least one screen.

The mixer 54 is a circuit that superimposes the OSD image stored in the OSD memory 60 onto the video signal VSI supplied from the color adjusting unit 53. After processing by the mixer 54, the OSD image is displayed on the video represented by the video signal VSI (in a foremost plane).

The transmitting unit 55 is a circuit that supplies the display panel 14 with the video signal VS2 as the video signal VSI obtained after the processing by the mixer 54. Specifically, the transmitting unit 55 is configured to input the video signal VS2 to a line buffer on a row-by-row basis and sequentially transmit pixels of one row stored in the line buffer to the display panel 14. In addition, the transmitting unit 55 is configured to transmit a horizontal synchronizing signal (HSYNC) at an end of a row and transmit a vertical synchronization signal (VSYNC) at an end of a screen. The horizontal synchronizing signal (HSYNC) and the vertical synchronization signal (VSYNC) also constitute a part of the video signal VS2. The receiving unit 31 in the timing controller 30 is a circuit that receives the thus supplied video signal VS2 and supplies the video signal VS2 to the gate line control unit 32. The gate line control unit 32 is a circuit that controls the potential of each of the plurality of gate lines GL on the basis of the video signal VS2 supplied from the receiving unit 31.

The memory control unit 63 is a circuit that writes the provisional stroke image SI generated by the MCU 40 to the OSD memory 60. The switching unit 62 is provided between the memory control unit 63, the OSD control unit 61, and the OSD memory 60. The switching unit 62 plays a role of connecting the memory control unit 63 to the OSD memory 60 when the memory control unit 63 writes the provisional stroke image SI to the OSD memory 60, and connects the OSD control unit 61 to the OSD memory 60 when the memory control unit 63 does not write the provisional stroke image SI to the OSD memory 60. Thus, the provisional stroke image SI is displayed on the video represented by the video signal VSI so as to be prioritized over the OSD image.

As described above, according to the computer 1 in accordance with the present embodiment, the provisional stroke image SI representing the same stroke as the stroke image generated by the host processor 12 is generated in parallel with the host processor 12, and is superimposed onto the video signal that has not yet been supplied to the timing controller 30. It is therefore possible to prevent a delay in display of the stroke image due to a delay in processing in the computer 1 (a wait for processing in the host processor 12 or the like) without the provision of an overlay engine in the timing controller 30.

In addition, according to the computer 1 in accordance with the present embodiment, the provisional stroke image SI can be superimposed onto the video signal VS2 by using the existing mixer 54 and the existing OSD memory 60. It is therefore possible to reduce a circuit scale as compared with a case where a dedicated overlay engine and a dedicated buffer are provided as in Patent Document 1.

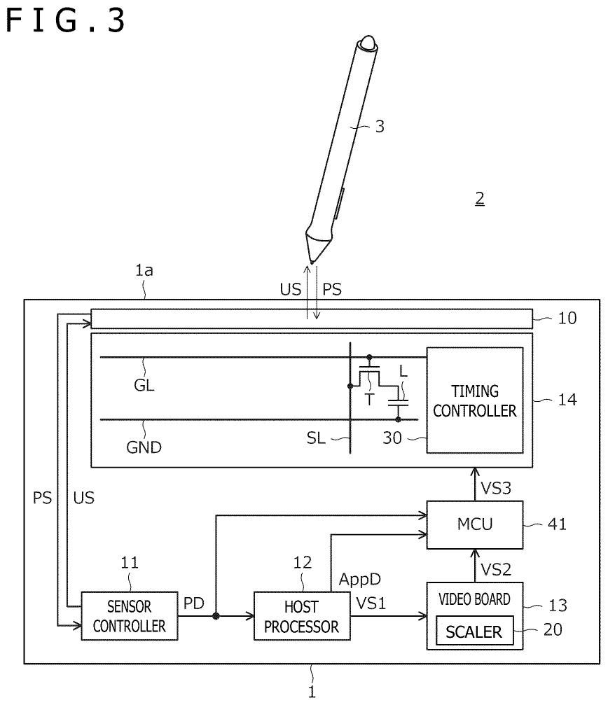

FIG. 3 is a diagram illustrating a configuration of a position detection system 2 including a computer 1 according to a second embodiment of the present disclosure. As is understood by comparing FIG. 3 with FIG. 1, the computer 1 according to the present embodiment is different from the computer 1 according to the first embodiment in that the computer 1 according to the present embodiment includes an MCU 41 in place of the MCU 40. The computer 1 according to the present embodiment is otherwise similar to the computer 1 according to the first embodiment. Accordingly, in the following, description will be continued with attention directed to differences from the computer 1 according to the first embodiment.

The MCU 41 is identical to the MCU 40 according to the first embodiment in terms of the processing of generating the provisional stroke image SI. On the other hand, the MCU 41 is different from the MCU 40 according to the first embodiment in that the MCU 41 itself superimposes the generated provisional stroke image SI onto the video signal VS2 output from the video board 13 instead of supplying the generated provisional stroke image SI to the scaler 20 and making the scaler 20 perform the processing of superimposing the generated provisional stroke image SI onto the video signal VS2. As described above, the output from the video board 13 is produced on a pixel-by-pixel basis. Thus, the MCU 41 is configured to determine timings in which to superimpose the respective pixels of the provisional stroke image SI by referring to the vertical synchronization signal (VSYNC) and the horizontal synchronizing signal (HSYNC) described above, and sequentially superimpose the respective pixels of the provisional stroke image SI onto the video signal VS2 in the determined timings. A video signal VS3 as the video signal VS2 obtained after the superimposition is directly supplied from the MCU 41 to the display panel 14. Receiving this supply, the display panel 14 performs processing for displaying video on the panel surface 1a on the basis of the video signal VS3 in place of the video signal VS2.

As described above, also according to the computer 1 in accordance with the present embodiment, the provisional stroke image SI representing the same stroke as the stroke image generated by the host processor 12 is generated in parallel with the host processor 12, and is superimposed onto the video signal that has not yet been supplied to the timing controller 30. It is therefore possible to prevent a delay in display of the stroke image due to a delay in processing in the computer 1 without the provision of an overlay engine in the timing controller 30.

In addition, according to the computer 1 in accordance with the present embodiment, the provisional stroke image SI can be generated and superimposed without the existing video board 13 and the existing display panel 14 being modified. It is therefore possible to achieve implementation easily as compared with a case where the timing controller is modified as in Patent Document 1.

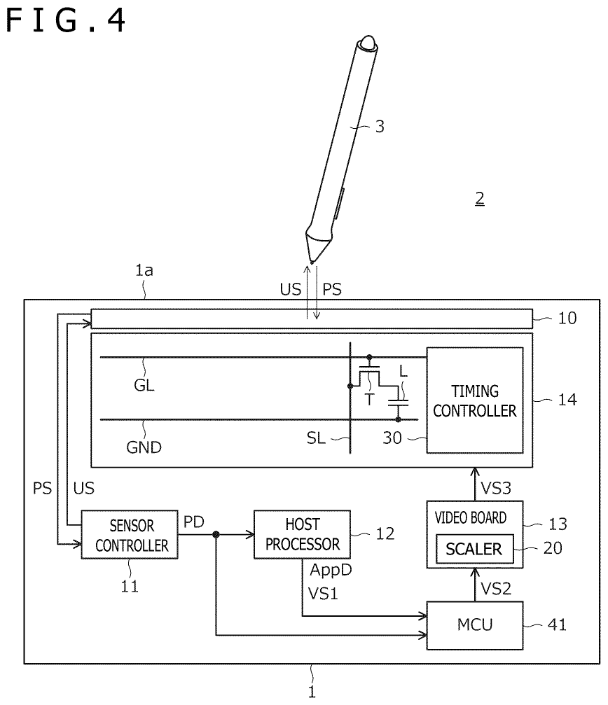

FIG. 4 is a diagram illustrating a configuration of a position detection system 2 including a computer 1 according to a third embodiment of the present disclosure. As is understood by comparing FIG. 4 with FIG. 3, the computer 1 according to the present embodiment is different from the computer 1 according to the second embodiment in that the MCU 41 is located in a stage preceding the video board 13 and in that the video signal VS1 generated by the host processor 12 is supplied to the MCU 41 instead of the video board 13. The computer 1 according to the present embodiment is otherwise similar to the computer 1 according to the second embodiment. Accordingly, in the following, description will be continued with attention directed to differences from the computer 1 according to the second embodiment.

The MCU 41 according to the present embodiment generates the video signal VS2 by superimposing the provisional stroke image SI generated on the basis of the series of pieces of pen data PD supplied from the sensor controller 11 onto the video signal VSI supplied from the host processor 12. The video board 13 according to the present embodiment plays a role of converting the video signal VS2 generated by the MCU 41 into a video signal VS3 as a signal corresponding to the display panel 14, and supplying the video signal VS3 obtained by this conversion to the display panel 14.

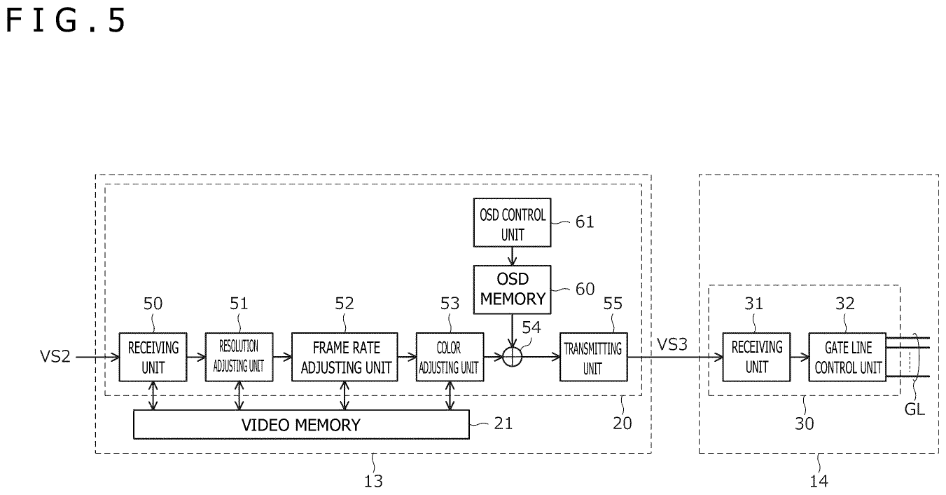

FIG. 5 is a diagram illustrating an internal configuration of the video board 13 and the display panel 14 according to the present embodiment. As illustrated in FIG. 5, the input signal of the video board 13 according to the present embodiment is the video signal VS2, and the output signal of the video board 13 according to the present embodiment is the video signal VS3. In addition, the scaler 20 according to the present embodiment includes neither of the switching unit 62 and the memory control unit 63. This is because, in the present embodiment, the video signal VS2 having the provisional stroke image SI already superimposed thereon is input to the video board 13, and therefore, the scaler 20 does not need to perform the processing of superimposing the provisional stroke image SI onto the video signal.

As described above, also according to the computer 1 in accordance with the present embodiment, the provisional stroke image SI representing the same stroke as the stroke image generated by the host processor 12 is generated in parallel with the host processor 12, and is superimposed onto the video signal that has not yet been supplied to the timing controller 30. It is therefore possible to prevent a delay in display of the stroke image due to a delay in processing in the computer 1 without the provision of an overlay engine in the timing controller 30.

In addition, also according to the computer 1 in accordance with the present embodiment, the provisional stroke image SI can be generated and superimposed without the existing video board 13 and the existing display panel 14 being modified. It is therefore possible to achieve implementation easily as compared with a case where the timing controller is modified as in Patent Document 1.

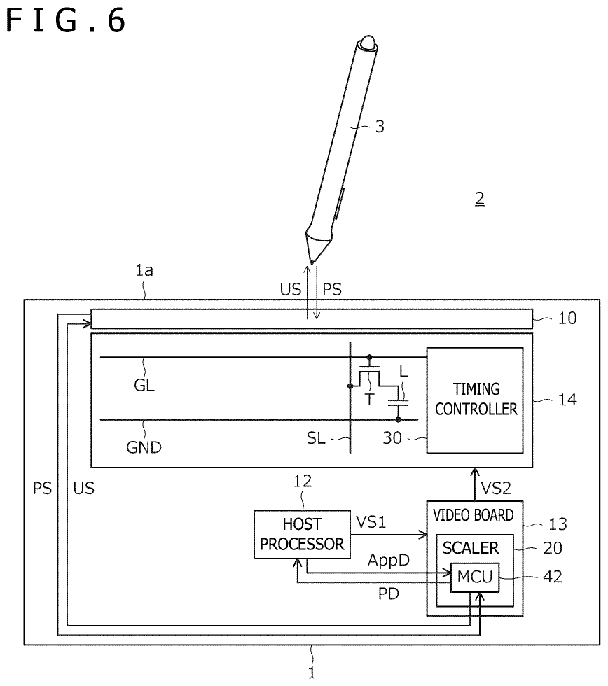

FIG. 6 is a diagram illustrating a configuration of a position detection system 2 including a computer 1 according to a fourth embodiment of the present disclosure. As is understood by comparing FIG. 6 with FIG. 1, the computer 1 according to the present embodiment is different from the computer 1 according to the first embodiment in that the computer 1 according to the present embodiment does not include the sensor controller 11 but includes an MCU 42 in place of the MCU 40. The computer 1 according to the present embodiment is otherwise similar to the computer 1 according to the first embodiment. Accordingly, in the following, description will be continued with attention directed to differences from the computer 1 according to the first embodiment.

The MCU 42 is provided in the scaler 20. The MCU 42 plays the role of the sensor controller 11 in the first embodiment, and as with the MCU 40 in the first embodiment, the MCU 42 also plays a role of generating, in parallel with the host processor 12, the provisional stroke image SI representing the same stroke as the stroke image generated by the host processor 12, and superimposing the provisional stroke image SI onto the video signal VS2 that has not yet been supplied to the timing controller 30.

With regard to the former role, the MCU 42 performs the processing of transmitting the uplink signal US to the electronic pen 3 via the sensor 10, and receiving the pen signal PS transmitted by the electronic pen 3 as a reflection signal in response to the uplink signal US via the sensor 10. In addition, the MCU 42 performs processing of deriving or obtaining the pen data PD on the basis of the received pen signal PS, and supplying the pen data PD to the host processor 12. The host processor 12 generates a stroke image on the basis of the thus supplied pen data PD.

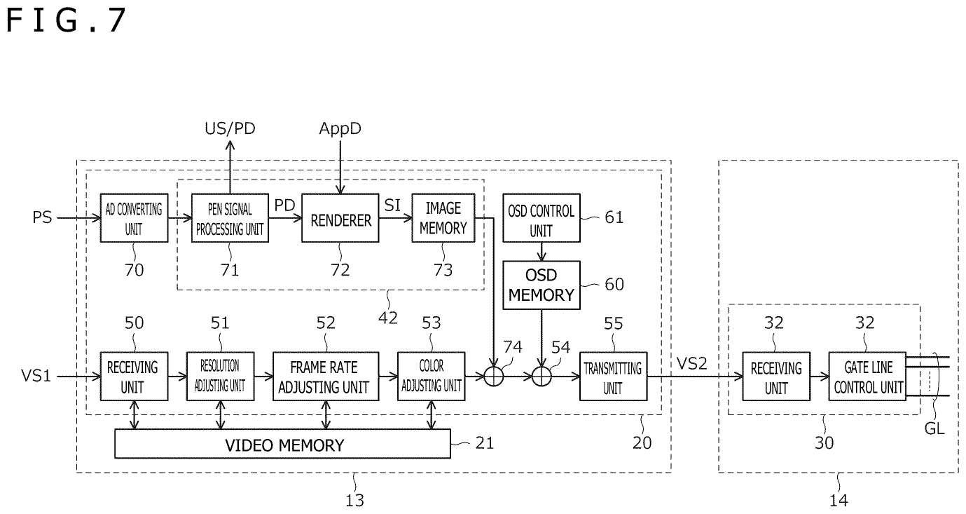

FIG. 7 is a diagram illustrating an internal configuration of the video board 13 and the display panel 14 according to the present embodiment. As is understood by comparing FIG. 7 with FIG. 2, the video board 13 according to the present embodiment is different from the video board 13 according to the first embodiment in that the video board 13 according to the present embodiment includes neither of the switching unit 62 and the memory control unit 63 and in that the video board 13 according to the present embodiment includes an AD converting unit 70, an MCU 42, and a mixer 74. The video board 13 according to the present embodiment is otherwise similar to the video board 13 according to the first embodiment. The display panel 14 has the same configuration as the display panel 14 according to the first embodiment.

The MCU 42 includes a pen signal processing unit 71, a renderer 72, and an image memory 73. The AD converting unit 70 is located in a stage preceding the pen signal processing unit 71. The AD converting unit 70 plays a role of converting the pen signal PS received in each of the loop coils in the sensor 10 into a digital signal, and supplying the digital signal to the pen signal processing unit 71.

As with the sensor controller 11 in the first embodiment, the pen signal processing unit 71 performs the processing of transmitting the uplink signal US to the electronic pen 3 via the sensor 10, and receiving the pen signal PS transmitted by the electronic pen 3 as a reflection signal in response to the uplink signal US via the sensor 10. In addition, the pen signal processing unit 71 performs the processing of deriving or obtaining the pen data PD on the basis of the received pen signal PS, and supplying the pen data PD to the host processor 12. The host processor 12 generates a stroke image on the basis of the thus supplied pen data PD.

The pen signal processing unit 71 supplies the derived or obtained pen data PD also to the renderer 72. The renderer 72 is supplied with the drawing data AppD from the host processor 12 in addition to the pen data PD. The renderer 72 generates the provisional stroke image SI on the basis of the pen data PD and the drawing data AppD thus supplied, and writes the generated provisional stroke image SI to the image memory 73. As with the OSD memory 60, the image memory 73 is a storage unit configured to be able to store an image of at least one screen.

The mixer 74 is a circuit that superimposes the provisional stroke image SI stored in the image memory 73 onto the video signal VSI output from the color adjusting unit 53. After the processing of the mixer 74, the provisional stroke image SI is displayed on the video represented by the video signal VS1 (in a foremost plane). The mixer 54 is provided in a stage subsequent to the mixer 74. Hence, when there is an OSD image to be displayed, the OSD image is displayed in a plane in front of the provisional stroke image SI.

As described above, also according to the computer 1 in accordance with the present embodiment, the provisional stroke image SI representing the same stroke as the stroke image generated by the host processor 12 is generated in parallel with the host processor 12, and is superimposed onto the video signal that has not yet been supplied to the timing controller 30. It is therefore possible to prevent a delay in display of the stroke image due to a delay in processing in the computer 1 without the provision of an overlay engine in the timing controller 30.

In addition, according to the computer 1 in accordance with the present embodiment, the OSD image can be displayed even when the provisional stroke image SI is displayed. Furthermore, the OSD image can be displayed in a plane in front of the provisional stroke image SI.

Further, according to the computer 1 in accordance with the present embodiment, the provisional stroke image SI is superimposed on the video signal VSI in a stage subsequent to the color adjusting unit 53. Thus, as with the OSD image, the provisional stroke image SI as a kind of CG can be displayed in a state of not being affected by the color correction of the color adjusting unit 53.

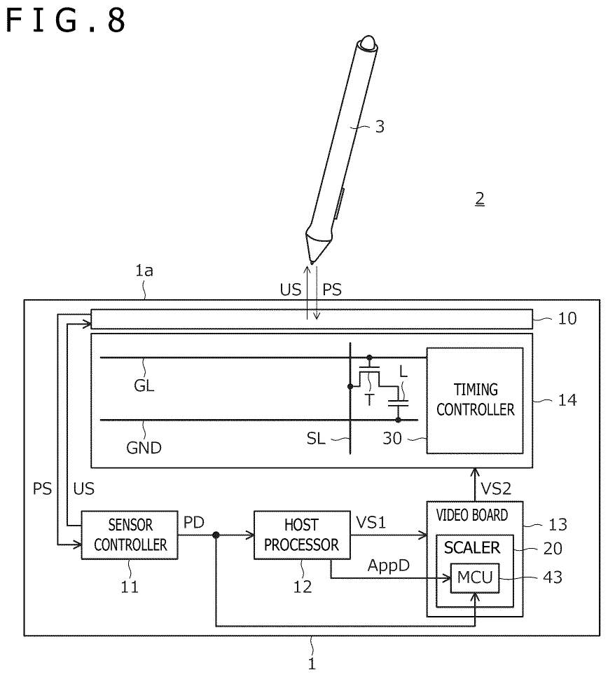

FIG. 8 is a diagram illustrating a configuration of a position detection system 2 including a computer 1 according to a fifth embodiment of the present disclosure. As is understood by comparing FIG. 8 with FIG. 6, the computer 1 according to the present embodiment is different from the computer 1 according to the first embodiment in that the computer 1 according to the present embodiment includes an MCU 43 in place of the MCU 40. The computer 1 according to the present embodiment is otherwise similar to the computer 1 according to the first embodiment. Accordingly, in the following, description will be continued with attention directed to differences from the computer 1 according to the first embodiment.

As with the MCU 42 described in the fourth embodiment, the MCU 43 is provided in the scaler 20. The MCU 43 has a role of generating, in parallel with the host processor 12, the provisional stroke image SI representing the same stroke as the stroke image generated by the host processor 12, and superimposing the provisional stroke image SI onto the video signal VS2 that has not yet been supplied to the timing controller 30. On the other hand, unlike the MCU 42 described in the fourth embodiment, the MCU 43 does not have the role as the sensor controller 11.

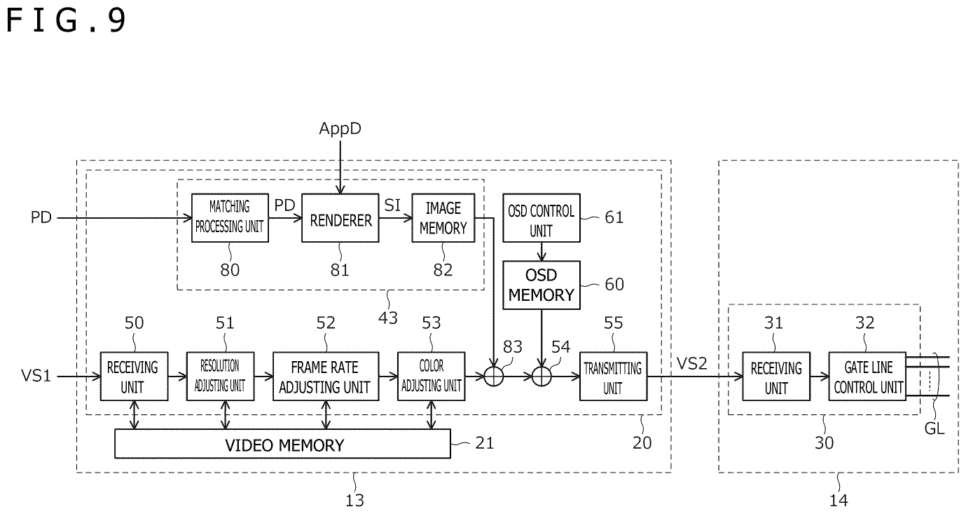

FIG. 9 is a diagram illustrating an internal configuration of the video board 13 and the display panel 14 according to the present embodiment. As is understood by comparing FIG. 9 with FIG. 2, the video board 13 according to the present embodiment is different from the video board 13 according to the first embodiment in that the video board 13 according to the present embodiment includes neither of the switching unit 62 and the memory control unit 63 and in that the video board 13 according to the present embodiment includes an MCU 43 and a mixer 83. The video board 13 according to the present embodiment is otherwise similar to the video board 13 according to the first embodiment. The display panel 14 has the same configuration as the display panel 14 according to the first embodiment.

The MCU 43 includes a matching processing unit 80, a renderer 81, and an image memory 82. Of these, the matching processing unit 80 is sequentially supplied with the pen data PD from the sensor controller 11. The matching processing unit 80 is configured to convert the coordinate data included in the pen data PD supplied thereto into coordinate data based on the coordinate system of the display panel 14 and supply the renderer 81 with the pen data PD including the coordinate data obtained after the conversion.

Functions and operation of the renderer 81, the image memory 82, and the mixer 83 are similar to the functions and operation of the renderer 72, the image memory 73, and the mixer 74 described in the fourth embodiment. Hence, also in the present embodiment, the provisional stroke image SI is displayed in a plane in front of the video represented by the video signal VSI and in back of the OSD image.

As described above, also according to the computer 1 in accordance with the present embodiment, the provisional stroke image SI representing the same stroke as the stroke image generated by the host processor 12 is generated in parallel with the host processor 12, and is superimposed onto the video signal that has not yet been supplied to the timing controller 30. It is therefore possible to prevent a delay in display of the stroke image due to a delay in processing in the computer 1 without the provision of an overlay engine in the timing controller 30.

In addition, also according to the computer 1 in accordance with the present embodiment, as in the fourth embodiment, the OSD image can be displayed even when the provisional stroke image SI is displayed. Furthermore, the OSD image can be displayed in a plane in front of the provisional stroke image SI.

Further, also according to the computer 1 in accordance with the present embodiment, as in the fourth embodiment, the provisional stroke image SI is superimposed on the video signal VSI in a stage subsequent to the color adjusting unit 53. Thus, as with the OSD image, the provisional stroke image SI as a kind of CG can be displayed in a state of not being affected by the color correction of the color adjusting unit 53.

Preferred embodiments of the present disclosure have been described above. However, the present disclosure is not at all limited to such embodiments, and it is a matter of course that the present disclosure can be carried out in various modes without departing from the spirit of the present disclosure.

For example, in the foregoing embodiments, description has been made of an example of a case where processing from the generation to the display of the stroke image is completed in the computer 1. However, the present disclosure is applicable also in a case where, when a remote connection to another computer is established by using an online conference app or the like, the stroke image generated by the host processor 12 is transmitted to the another computer, and the stroke image is included also in an image transmitted from the another computer to the computer 1. That is, an even larger delay than in the case where the processing from the generation to the display of the stroke image is completed in the computer 1 occurs until the stroke image generated in the computer 1 is displayed in the image transmitted from the another computer to the computer 1. However, it is possible to prevent a delay in display of the stroke image also in such a case by displaying the provisional stroke image in the image transmitted from the another computer to the computer 1 by the processing of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### DESCRIPTION OF REFERENCE SYMBOLS

1: Computer
1a: Panel surface
2: Position detection system
3: Electronic pen
10: Sensor
11: Sensor controller
12: Host processor
13: Video board
14 Display panel
20: Scaler
21 Video memory
30: Timing controller
31, 50: Receiving unit
32: Gate line control unit
51: Resolution adjusting unit
52: Frame rate adjusting unit
53: Color adjusting unit
54, 74, 83: Mixer
55: Transmitting unit
60: OSD memory
61: OSD control unit
62: Switching unit
63: Memory control unit
70: AD converting unit
71: Pen signal processing unit
72, 81: Renderer
73, 82: Image memory
80: Matching processing unit
AppD: Drawing data
GL: Gate line
GND: Common grounding wiring
L: Liquid crystal clement
PD: Pen data
PS: Pen signal
SI: Provisional stroke image
SL Signal line
T: Thin film transistor
US: Uplink signal
VS1 to VS3: Video signal

1. A computer comprising:
a host processor that, in operation, generates a stroke image representing a stroke indicated by a series of pieces of coordinate data each representing a position of a pen in a touch surface, and generates a video signal representing the stroke image;
a timing controller that, in operation, controls a potential of each of a plurality of gate lines arranged in a display, based on the video signal; and
a provisional stroke image generating processor that, in operation, generates, in parallel with the host processor, a provisional stroke image representing a same stroke as the stroke represented by the stroke image,
wherein the provisional stroke image is superimposed onto the video signal before the video signal is supplied to the timing controller.

2. The computer according to claim 1, further comprising:
a scaler that, in operation, converts the video signal output from the host processor into a signal corresponding to the display and supplies to the timing controller the video signal after the video signal output from the host processor is converted into the signal corresponding to the display,
wherein the scaler includes:
an on-screen display memory that, in operation, stores an on-screen display image to be superimposed onto the video signal, and
a mixer that, in operation, superimposes the on-screen display image stored in the on-screen display memory onto the video signal, and
wherein the provisional stroke image generating processor, in operation, writes the provisional stroke image to the on-screen display memory.

3. The computer according to claim 2, further comprising:
a sensor controller that, in operation, derives the series of pieces of coordinate data based on a pen signal received from the pen, and outputs the series of pieces of coordinate data to each of the host processor and the provisional stroke image generating processor,
wherein the provisional stroke image generating processor, in operation, generates the provisional stroke image based on the series of pieces of coordinate data supplied from the sensor controller.

4. The computer according to claim 1, further comprising:
a scaler that, in operation, converts the video signal output from the host processor into a signal corresponding to the display, and outputs the video signal after the video signal output from the host processor is converted into the signal corresponding to the display to the provisional stroke image generating processor,
wherein the provisional stroke image generating processor, in operation, superimposes the provisional stroke image onto the video signal output from the scaler, and supplies to the timing controller the video signal after the provisional stroke image is superimposed onto the video signal.

5. The computer according to claim 4, further comprising:
a sensor controller that, in operation, derives the series of pieces of coordinate data based on a pen signal received from the pen, and outputs the series of pieces of coordinate data to each of the host processor and the provisional stroke image generating processor,
wherein the provisional stroke image generating processor, in operation, generates the provisional stroke image based on the series of pieces of coordinate data supplied from the sensor controller.

6. The computer according to claim 1, further comprising:
a scaler that, in operation, converts the video signal output from the host processor into a signal corresponding to the display, superimposes the provisional stroke image onto the signal after the video signal output from the host processor is converted into the signal corresponding to the display, and supplies to the timing controller the video signal after the provisional stroke image is superimposed onto the video signal.

7. The computer according to claim 6, wherein
the provisional stroke image generating processor, in operation, derives the series of pieces of coordinate data based on a pen signal received from the pen, outputs the series of pieces of coordinate data to the host processor, and generates the provisional stroke image based on the series of pieces of coordinate data.

8. The computer according to claim 6, further comprising:
a sensor controller that, in operation, derives the series of pieces of coordinate data based on a pen signal received from the pen, and outputs the series of pieces of coordinate data to each of the host processor and the provisional stroke image generating processor,
wherein the provisional stroke image generating processor, in operation, generates the provisional stroke image based on the series of pieces of coordinate data supplied from the sensor controller.
